(19) United States
(12) Patent Application Publication
(10) Pub. No.: US 2025/0287235 A1
(43) Pub. Date: Sep. 11, 2025

(54) SYSTEM AND METHOD FOR IMPROVING DELIVERY OF NETWORK SERVICES USING A HANDOVER NOTIFICATION MESSAGE

(71) Applicant: DISH Wireless L.L.C., Englewood, CO (US)

(72) Inventors: Raghavendhra Rao, Littleton, CO (US); Mehdi Alasti, Arlington, VA (US)

(73) Assignee: DISH Wireless L.L.C., Englewood, CO (US)

(21) Appl. No.: 18/601,051

(22) Filed: Mar. 11, 2024

(51) Int. Cl. H04W 24/08; H04W 36/32; H04W 76/50; H04W 84/04

(52) U.S. Cl. CPC H04W 24/08; H04W 36/322; H04W 76/50; H04W 84/042

(57) ABSTRACT

A method and system for detecting, at a network function of a core network (CN), a handover of a connection between a user equipment (UE) device and the CN from a first access network (AN) to a second AN; issuing, to an application programming interface (API) of the CN, a handover notification associated with the detected handover; determining, at the API, one or more service update messages to another one or more network functions of the CN, each of the one or more service update messages relating to a respective one or more application features at the UE device and/or the CN; and issuing, at the API, the determined one or more service update messages to the other one or more network functions to facilitate the respective one or more application features at the UE device and/or the CN in correspondence with the detected handover.

### FIELD

The present disclosure generally relates to wireless communication networks and, more specifically, to a communication network system and method for augmenting higher layer services, including new services and enhanced existing services, to a user equipment device using handover notification messages.

### BACKGROUND

Telecommunication networks continue to advance with services being added, updated, and augmented along with the continued developments in newer generations of network systems and protocols. Consequently, the services available and/or the quality of service provided across different network environments can vary. For example, services provided to a user equipment device can differ depending upon the access network through which it connects to a service provider core network.

One of the advances in the 5G standard relates to handover notification services provided by a core network (CN) that allows for continuous communications and/or service delivery from the core network to a user equipment (UE) device across access networks (ANs). Handovers among such ANs can result in changes to services available and/or the quality of service (QOS) delivered to a UE device depending upon the protocol and/or any constraints associated with the respective ANs.

At present, many services are optimized to perform within a given radio access technology (RAT) or other network technologies. However, these services and applications operate on a higher layer and are not aware of handovers in the call session plane. For example, a location processing session or a voice/video session would have no knowledge of an inter-RAT handover in a voice call session domain. As such, a subscriber expecting seamless coverage and continuous service can experience degraded services or loss of service continuity when, knowingly or unknowingly, moving across coverage areas of ANs and subjected to handovers.

### SUMMARY

The present disclosure provides for using an extended handover notification mechanism to facilitate higher layer services, including new enhanced services and/or improved/optimized existing services, for example, to a UE device of, say, a residential or enterprise customer. In exemplary implementations, a higher layer handover notification mechanism is provided so that applications and services can deliver continuous connectivity and maintain a continuous and uninterrupted user experience without degradation in quality when a UE device is experiencing a handover by executing more seamless and efficient transfers of ongoing communication sessions using the extended handover notification mechanism. In certain embodiments, the extended handover notification mechanism is applicable to internet of things (IoT) devices, 5G Redcap devices, or the like, in performing one or more application features in correspondence with handovers involving such devices.

In particular, the disclosure relates to a method and system that detects at a network function of a core network (CN), a handover of a connection between a user equipment (UE) device and the CN from a first access (or source) network (AN) to a second (or target) AN. Then an application programming interface (API) of the CN issues a handover notification associated with the detected handover and determines one or more service update messages to issue to the other one or more network functions of the CN. Each of the one or more service update messages relates to a respective one or more application features at the UE device and/or the CN, and is associated with a change from the first AN to the second AN. The API additionally issues the determined one or more service update messages to the other one or more network functions to facilitate the respective one or more application features at the UE device and/or the CN in correspondence with the detected handover.

In a general aspect, a method performed at a core network is provided. The method includes detecting, at a network function of a CN, a handover of a connection between a UE device and the CN from a first AN to a second AN. The method further includes issuing, at the network function to an API of the CN, a handover notification associated with the detected handover. The method further includes determining, at the API, one or more service update messages to another one or more network functions of the CN, wherein each of said one or more service update messages relates to a respective one or more application features at one or more of the UE device and the CN, and is associated with a change from the first AN to the second AN. The method further includes issuing, at the API, the determined one or more service update messages to the other one or more network functions to facilitate the respective one or more application features at the one or more of the UE device and the CN in correspondence with the detected handover.

Implementations of the method can include one or more of the following features.

The handover notification can incorporate at least one information indicator on an application layer associated with the API, the at least one information indicator being selected from the group consisting of: a time of an event associated with the detected handover, a location of the event associated with the detected handover, a type of the handover, a direction of the handover, a Public Land Mobile Network (PLMN) identification (ID), a cell ID, an update counter, an initial attempt indicator for the handover or an update, and a handover attempt success indicator.

The network function can include an access and mobility management function (AMF) or a mobility management entity (MME). The handover notification can be issued to the API via a network exposure function (NEF).

The another one or more respective network functions can be selected from the group consisting of: a policy control function (PCF), a network function repository function (NRF), a session management function (SMF), a location management function (LMF), a gateway mobility location center (GMLC), a serving mobile location center (SMLC), a network exposure function (NEF), an application function (AF), a user plane function (UPF), and a network data analytics function (NWDAF).

The at least one of the one or more application features can be related to a UE device location service (LCS). The at least one of the one or more service update messages can be related to a change from a first positioning determination scheme associated with the first AN to a second positioning determination scheme associated with the second AN. The at least one service update message can include a data request to a location management function (LMF) or a gateway mobility location center (GMLC). The first AN can include a wireless network conforming to a Wi-Fi standard protocol. The second AN can include a radio access network (RAN) conforming to a radio communication standard protocol. The first AN can include a RAN conforming to a radio communication standard protocol. The second AN can include a wireless network conforming to a Wi-Fi standard protocol. The method can further include transmitting, at the API, location data received from the LMF or the GMLC to a public safety answering point (PSAP) for an emergency call connected via the second AN.

The at least one of the one or more application features can relate to a video display application of an ongoing video being displayed at the UE device. The one or more service update messages can include a data request to a policy control function (PCF) to determine a change in network resources available for the video display application. The method can further include issuing, at the API, at least one of a state change request and a time stamp request to the video display application.

The at least one of the one or more application features can relate to one or more analytical processes associated with the CN. The one or more service update messages can include analytical data for a network data analytics function (NWDAF). The NWDAF can include one or more of an analytics logical function (AnLF) and a model training logical function (MTLF).

In another general aspect, a system is provided. The system includes an interface adapted to communicate with one or more user equipment (UE) devices, a processor, and a non-transitory computer-readable memory operatively connected to the processor and having stored thereon machine-readable instructions that cause, when executed, the processor to perform operations. The operations include a step to detect, at a network function of a core network (CN), a handover of a connection between a UE device and the CN from a first access network (AN) to a second AN. The operations further include a step to issue, at the network function to an application programming interface (API) of the CN, a handover notification associated with the detected handover. The operations further include a step to determine, at the API, one or more service update messages to another one or more network functions of the CN, wherein each of said one or more service update messages relates to a respective one or more application features at one or more of the UE device and the CN, and is associated with a change from the first AN to the second AN. The operations further include a step to issue, at the API, the determined one or more service update messages to the other one or more network functions to facilitate the respective one or more application features at the one or more of the UE device and the CN in correspondence with the detected handover.

Implementations of the system can include one or more of the following features.

The handover notification can incorporate at least one information indicator on an application layer associated with the API, the at least one information indicator being selected from the group consisting of: a time of an event associated with the detected handover, a location of the event associated with the detected handover, a type of the handover, a direction of the handover, a Public Land Mobile Network (PLMN) identification (ID), a cell ID, an update counter, an initial attempt indicator for the handover or an update, and a handover attempt success indicator.

The network function can include an access and mobility management function (AMF) or a mobility management entity (MME). The handover notification can be issued to the API via a network exposure function (NEF).

The another one or more respective network functions can be selected from the group consisting of: a policy control function (PCF), a network function repository function (NRF), a session management function (SMF), a location management function (LMF), a gateway mobility location center (GMLC), a serving mobile location center (SMLC), a network exposure function (NEF), an application function (AF), a user plane function (UPF), and a network data analytics function (NWDAF).

The at least one of the one or more application features can relate to a UE device location service (LCS). The at least one of the one or more service update messages can relate to a change from a first positioning determination scheme associated with the first AN to a second positioning determination scheme associated with the second AN. The at least one service update message can include a data request to a location management function (LMF) or a gateway mobility location center (GMLC). The first AN can include a wireless network conforming to a Wi-Fi standard protocol. The second AN can include a radio access network (RAN) conforming to a radio communication standard protocol. The first AN can include a RAN conforming to a radio communication standard protocol. The second AN can include a wireless network conforming to a Wi-Fi standard protocol. The operations can further include a step to transmit, at the API, location data received from the LMF or the GMLC to a public safety answering point (PSAP) for an emergency call connected via the second AN.

The one or more application features can relate to a video display application of an ongoing video being displayed at the UE device. The one or more service update messages can include a data request to a policy control function (PCF) to determine a change in network resources available for the video display application. The operations can further include a step to issue, at the API, at least one of a state change request and a time stamp request to the video display application.

The at least one of the one or more application features can relate to one or more analytical processes associated with the CN. The one or more service update messages can include analytical data for a network data analytics function (NWDAF). The NWDAF can include one or more of an analytics logical function (AnLF) and a model training logical function (MTLF).

### BRIEF DESCRIPTION OF THE DRAWINGS

Various exemplary implementations of this disclosure will be described in detail, with reference to the following figures, wherein:

FIG. 1 is a schematic diagram illustrating a handover scenario according to one or more exemplary implementations of the present disclosure.

FIG. 2 is a schematic diagram depicting certain network elements in the core network of FIG. 1 according to one or more exemplary implementations of the present disclosure.

FIG. 3 is a flow diagram illustrating a handover notification process according to one or more exemplary implementations of the present disclosure.

FIG. 4 is a schematic diagram for showing examples of a computing apparatus and a mobile computing device for implementing the techniques of the present disclosure.

### DETAILED DESCRIPTION

As an overview, the present disclosure generally concerns handovers of user equipment (UE) device network connections among access networks (ANs). More specifically, the present disclosure provides for utilizing handover notification messages that are transmitted during such handovers for improving delivery of higher layer services to the UE device.

According to one or more exemplary implementations of the present disclosure, the handover mechanism for delivering the application layer services is executed for a UE device connected to a core network (CN) through various ANs before and after a handover. In certain embodiments, one or more internet of things (IoT) devices, 5G RedCap devices, or the like, can be used and the handover mechanism can be used for performing one or more application features in correspondence with handovers involving such devices.

The CN and one or more of the ANs can together form a cellular network architecture that conforms to a current generation radio communication standard protocol, such as the 5G network specifications (or standards) described in the 3rd Generation Partnership Project (3GPP) Technical Specification (TS) 23.501, which is incorporated herein by reference as if set forth in its entirety. In embodiments, one or more of the CN and the ANs can include elements that operate in other network environments-such as 4G, Wi-Fi, WiMAX, Citizens Broadband Radio Service (CBRS), to name a few. The attendant specifications (or standards) for such network environments—for example, 3GPP TS 23.401 for 4G and the Institute of Electrical and Electronics Engineers (IEEE) 802 for local area networks (LANs), personal area networks (PANs), and metropolitan area networks (MANs), including, for example, 802.11 for Wi-Fi and 802.16 for WiMAX—are, likewise, incorporated herein by reference as if set forth in their entireties. As described herein, a network environment (sometimes referred to herein simply as a network or an environment) refers to multiple apparatuses, modules, elements, and/or functions that incorporate hardware and/or software and operate to form one or more CNs and one or more ANs that enable wireless communication for a UE device.

The following exemplary implementations are described based on a 5G CN and handovers involving a 5G radio access network (RAN), features of which can be incorporated into other types of networks without departing from the spirit and the scope of the present disclosure.

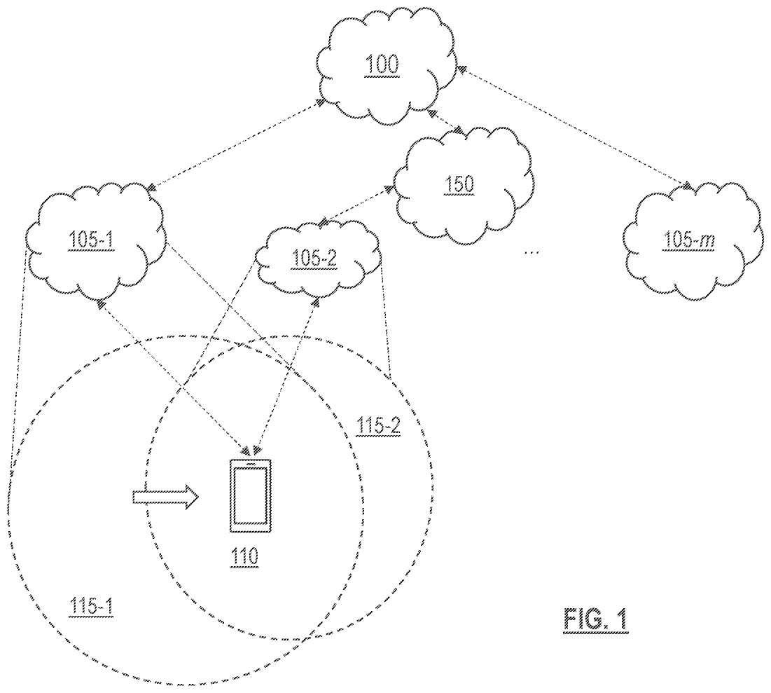

FIG. 1 is a schematic diagram illustrating a handover scenario involving a CN 100 and ANs 105 according to one or more exemplary implementations of the present disclosure. As illustrated in FIG. 1, CN 100 is in communication with multiple ANs 105-1, 105-2, . . . , 105-m (2<=m) through which a UE device 110 can be connected to CN 100 for wireless communications. In embodiments, ANs 105 can be RANs conforming to a current generation radio communication standard protocol such as the 5G standards, the 4G standards, wireless networks conforming to the Wi-Fi or WiMAX standards in conjunction with one or more external networks (such as the Internet), to name a few. UE device 110 is depicted in FIG. 1 as being situated in a coverage area 115-1 of AN 105-1 that overlaps with a coverage area 115-2 of AN 105-2. For example, UE device 110 can be carried by a subscriber traveling between cells, between areas with cell coverage and Wi-Fi coverage, or the like. In such situations, a handover takes place between a source AN to a destination AN, for example, from AN 105-1 to AN 105-2 in the example shown in FIG. 1, where UE device 110 is traveling in the direction indicated by the rightward arrow. In other words, a connection of UE device 110 to AN 105-1 is “handed over” to AN 105-2.

In the example illustrated in FIG. 1, AN 105-1 is a 5G new radio (NR) RAN conforming to the 5G standards and AN 105-2 is a Wi-Fi local area network (WLAN), which is in communication with CN 100 through an external network 150, such as the Internet. As part of the handover, messages are exchanged among UE device 110, CN 100, AN 105-1 and AN 105-2 for releasing the connection between UE device 110 and AN 105-1, and for establishing a connection between UE device 110 and AN 105-2. According to one or more exemplary implementations of the present disclosure, a handover notification message is exchanged among network elements. In a manner of description associated with service-based system architectures, network function messages in CN 100 are forwarded to one or more other network elements to affect higher layer services associated with UE device 110 after the handover. Additionally, in certain embodiments, such messages can correspond to one or more new services, for example, based on 5G service based mechanisms, to which other network nodes and services can subscribe so as to receive relevant messages for such new services.

One of ordinary skill in the art can appreciate that the present disclosure can also be applied to a handover in the opposite direction, between others of the ANs 105, between slices of CN 100, or to/from other networks (not shown) without departing from the spirit and scope of the disclosure. As one example, the present disclosure can be applied to inter-system handovers as described in U.S. patent application Ser. No. 18/135,587 filed on Apr. 17, 2023, which is incorporated herein by reference as if set forth in its entirety.

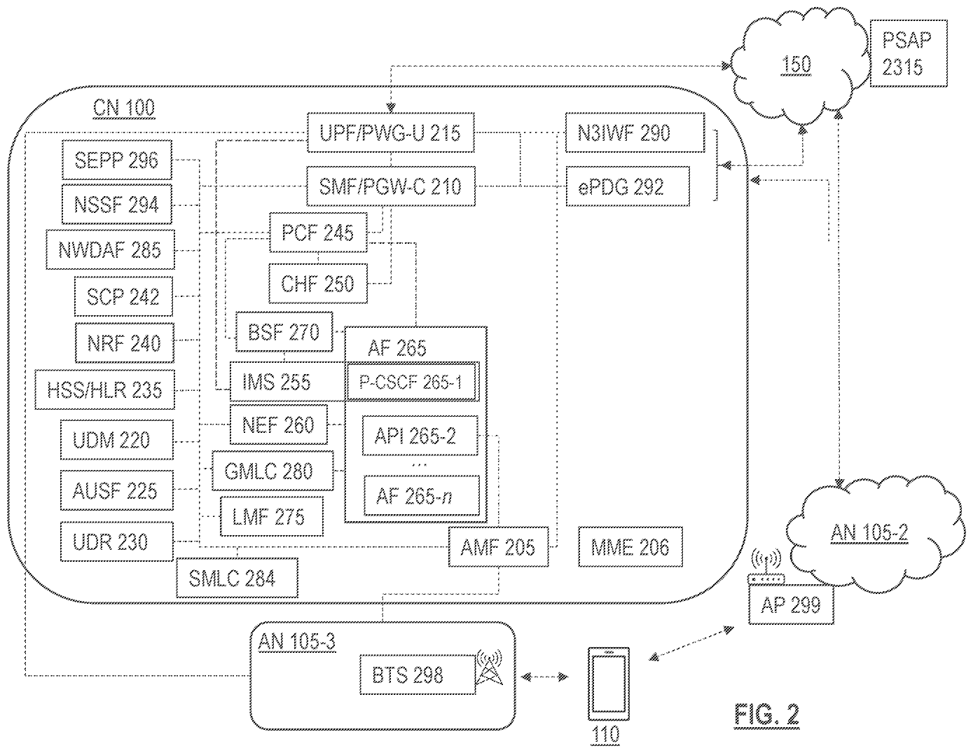

FIG. 2 is a schematic diagram depicting certain network elements of CN 100 that are involved in a handover, as depicted in FIG. 1, according to one or more exemplary implementations of the present disclosure. FIG. 2 depicts CN 100 according to a service-based system architecture with network elements, or network functions, interconnected via a common bus that operates in compliance with the 5G network standards. However, FIG. 2 is not intended to be limiting with respect to the 5G network standards or otherwise. The present disclosure contemplates a current generation radio communication standard protocol that advances beyond the 5G network standards, for example, to a 6G set of standards and so on. As such, certain features described herein can be applicable to any current generation radio communication standard protocol, which can include interoperability with one or more previous generation radio communication standard protocols, such as the 2G standards, the 2.5G standards, the 3G standards, 4G standards, and the like. The lines depicted in FIG. 2 indicate possible direct communications among any two or more of the network elements. Certain of the processes of the present disclosure can be executed over point-to-point interfaces among the depicted network elements as can be appreciated by one of ordinary skill in the art. As can be appreciated by one of ordinary skill in the art, the network elements of CN 100 illustrated in FIG. 2 can be embodied as multiple respective instances serving respective ones of multiple subscribers and/or their multiple UE devices 110.

As illustrated in FIG. 2, CN 100 is a packet core network that comprises an access and mobility management function (AMF) 205, which supports encrypted signaling associated with UE device 110, for example, for handovers involving UE device 110. CN 100 further includes a session management function and packet data network gateway-control module (SMF/PGW-C) 210 that manages a session of UE device 110 and a user plane function and packet data network gateway-user plane module (UPF/PGW-U) 215 that processes and forwards user data, for example, between UE device 110 and external data network 150, such as the Internet. According to one or more exemplary implementations, AMF 205 forwards messages related to session management between UE device 110 and SMF/PGW-C 210. SMF/PGW-C 210 manages UE device sessions and, in doing so, interacts with other network functions, including asserting functional control of UPF/PGW-U 215, for example, traffic and/or quality of service (QOS) related features. In certain embodiments, AMF 205 can comprise a mobility management entity (MME) 206 for interoperability with 4G networks and, for example, long term evolution (LTE) RANS, which can be embodied by one or more of ANs 105.

CN 100 further comprises a unified data management (UDM) module 220 for managing user or subscriber information, an authentication service function (AUSF) 225 for user authentications and a unified data repository (UDR) 230 for storing a user database. The UDM 220 communicates with the AMF 205, AUSF 225, and the UDR 230 to provide centralized control of network user data. For interworking with 2G, 3G, and 4G network elements (for example), CN 100 further comprises a Home Subscriber System and Home Location Register (HSS/HLR) module 235, which stores subscriber information, location and SIM details, and authentication keys.

For services provided and consumed by the various network functions, CN 100 comprises a network repository function (NRF) 240 and a service communication proxy (SCP) 242. NRF 240 is a repository of all registered services provided by various network functions of CN 100, including instances of these network functions that are available for the corresponding services. SCP 242 serves as a single point of entry for clusters of network functions and provides a central control point for one or more such clusters in the signaling network core.

For policy control and charging, CN 100 comprises a policy control function (PCF) 245 and a charging function (CHF) 250. PCF 245 interacts with AMF 205, SMF/PGW-C 210, UDR 230, and certain other network functions of CN 100 for providing policy features that can be session and/or subscriber (e.g., UE device 110) related. According to one or more exemplary implementations, PCF 245 governs control plane functions via defined policy rules. CHF 250 interacts with PCF 245 and SMF/PGW-C 210 to provide support for charging services.

For voice services, CN 100 comprises an internet protocol (IP) multimedia subsystem (IMS) network 255, which is an application core network that supports voice services, messaging, voice calls, etc., to subscribers, e.g., UE device 110. In certain embodiments, IMS network 255 can be separate from CN 100. According to one or more exemplary implementations, IMS network 255 conforms to the 3GPP TS 26.114 on “IP Multimedia Subsystem (IMS); Multimedia telephony; Media handling and interaction,” which is incorporated herein by reference as if set forth in its entirety.

For communicating handover notifications to one or more applications, CN 100 comprises a network exposure function (NEF) 260 that supports interactions by network functions of CN 100 with applications that are executed to provide service features to a subscriber (e.g., UE device 110) and one or more application functions (AF) 265. NEF 260 provides communications to and from applications (or AF(s) 265), including providing for applications to trigger devices for example, UE device 110, to execute actions. In accordance with an exemplary implementation of the present disclosure, NEF 260 monitors AMF 205 and in certain cases UDM 220, for handovers, and communicates with one or more AFs 265 based on detected handovers. Additionally, NEF 260 provides for data provisioning from AF(s) 265 to AMF 205 for tuning CN 100 settings, facilitating state changes for UE devices, and/or optimizing network signaling capacity. NEF 260 further provides certain policy (e.g., QoS) and charging controls to AF(s) 265. In certain embodiments, CN 100 can incorporate direct proprietary connections between one or more of AF(s) 265 and the other network elements, for example, AMF 205. FIG. 2 includes a dot-dash line that illustrates an example of one such direct connection between AF 265-2 and AMF 205.

According to one or more exemplary implementations, AFs 265 comprise multiple application functions. As illustrated in FIG. 2, a Proxy-Call Session Control Function (P-CSCF) 265-1, which serves as a first contact point for users of the voice services of IMS 255, is an AF of CN 100 according to one or more exemplary implementations of the present disclosure. AFs 265 further comprise Application Programming Interface (API) 265-2 and other AFs . . . , to AF 265-n (1<=n). In certain embodiments, the API can be implemented as AF 265-1.

API 265-2 is an AF adapted to receive notifications of detected handovers at CN 100, process the detected handovers to determine appropriate service and/or policy changes, and issue requests to other network elements to effectuate the processed changes based on the detected handovers. In one or more exemplary implementations, API 265-2 operates at least in part on an application layer in connection with executing one or more application features for CN 100 and/or UE device 110. In certain embodiments, API 265-2 can be a separate network element of CN 100.

In certain embodiments, AF(s) 265-n can further include respective features associated with applications that are executed at, or provided to, UE device 110. As with other network elements, AF(s) 265 can produce services for and/or consume services of the network elements of CN 100. Such services can be provisioned via a subscription mechanism among the network elements, for example, via NEF 260.

For tracking sessions of subscribers (e.g., UE devices), CN 100 comprises a binding support function (BSF) 270 for tracking sessions that share common criteria, such as subscriber identifiers. As illustrated in FIG. 2, BSF 270 communicates with the PCF 245 and binds application function requests from AFs 265 to specific instances of PCF 245, which enables policy scaling at CN 100.

For locating UE devices using network capabilities, CN 100 comprises a location management function (LMF) 275 and a gateway mobile location center (GMLC) 280 according to one or more exemplary implementations. LMF 275 provides location determinations, or location services (LCS), to AMF 205, when queried, by calculating the position of a UE device (e.g., UE device 110) based on interactions between a radio network (e.g., AN 105-1) and/or the UE device. According to one or more exemplary implementations, LMF 275 communicates with the relevant radio network (e.g., AN 105-1) for location determinations via AMF 205. GMLC 280 serves as an interface between AMF and external applications, for example, via AF(s) 265 and provides location determination information to the external applications for location-based services (LBS). In certain embodiments, one or more base stations of an AN 105, for example, base transceiver station (BTS) 298 of AN 105-1, can be in communication with a base station controller (BSC) (not shown) and/or a serving mobile location center (SMLC) (or an evolved serving mobile location center (E-SMLC)) 284, which SMLC 284 determines network-based locations of UE devices, for example, UE device 110, based on radio signal measurements.

According to one or more exemplary implementations, CN 100 comprises a network data analytics function (NWDAF) 285, which collects data from network elements (or network functions) of CN 100 using event exposure services offered by these elements to return analytics data, for example, using an analytics logical function (AnLF) (not shown). In certain embodiments, NWDAF 285 can also collect data from an operation and management system (O&M) (not shown) of CN 100, as well as subscriber-related data from UDR 230. In certain embodiments, NWDAF 285 can incorporate machine learning (ML)/artificial intelligence (AI) training and deployment features for providing analytics data, for example, using a model training logical function (MTLF). According to one or more exemplary implementations, NWDAF 285 conforms to the 3GPP TS 23.288 according to “Architecture enhancements for 5G System (5GS) to support network data analytics services,” which is incorporated herein by reference as if set forth in its entirety.

As further illustrated in FIG. 2, CN 100 comprises a non-3GPP interworking function (N3IWF) 290, an evolved packet data gateway (ePDG) 292, a network slice selection function (NSSF) 294, and a security edge protection proxy (SEPP) 296 according to one or more exemplary implementations of the present disclosure.

The N3IWF 225 facilitates access from UE devices to CN 100 over non-3GPP ANs, such as WLANs through the Internet, or the like. N3IWF 225 communicates with AMF 205 that is serving a UE device (e.g., UE device 110) for a handover to a non-3GPP AN and establishes an interface with UPF/PWG-U 215 for data transmissions thereafter. ePDG 230 serves a similar purpose that is specified for evolved packet system (EPS) architectures, which apply for interoperability between certain 5G and 4G networks. ePDG 230 connects to SMF/PGW-C 210 and UPF/PWG-U 215 based on an evolved packet core (EPC) architecture of a 4G packet data network gateway (PGW). In certain embodiments, access by UE device 110 to CN 100 through an external data network, such as AN 105-2 and network 150, can be facilitated by either N3IWF 225 or ePDG 230 depending upon the architecture and environment of AN 105-2 and/or elements of network 150.

NSSF 294 provides for the selection of one or more different network slices supported by CN 100 and requested by a UE device (e.g., UE device 110), which slice selection can also be implemented by AMF 205 and/or AN 105. In certain embodiments, the different network slices (not shown) comprise respective combinations of network element instances of CN 100 for serving respective UE devices.

SEPP 296 is a security proxy for all signaling traffic across different operator networks, for example, for establishing a secure connection between a visited network, such as visited public land mobile network (VPLMN), and a home network, such as home public land mobile network (HPLMN), when a subscriber is roaming and the UE device 110 is connected to the VLPLMN. In some embodiments, CN 100 can be a VPLMN for a non-subscriber UE device (not shown) and a HPLMN for a subscriber UE device (e.g., UE device 110).

For communications between UE device 110 and CN 100 over a wireless 5G NR connection via AN 105-1, a BTS (or gNodeB, “gNB”) 298, which is a 5G NR base station, communicates, either directly or indirectly, with the packet core network elements, such as AMF 205, SMF/PGW-C module 210, and UPF+PGW-U module 215.

For communications between the UE device 110 and CN 100 via AN 105-2, UE device 110 accesses AN 105-2 through a Wi-Fi access point (AP) 299.

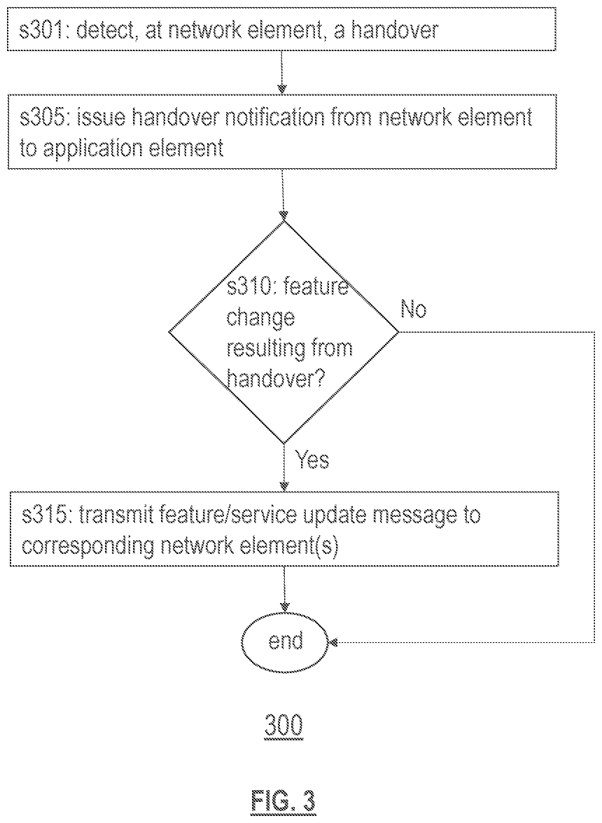

FIG. 3 is a flow diagram depicting a handover notification process 300 upon completion of a handover from AN 105-1 to AN 105-2 for a connection between CN 100 and UE device 110, as shown in FIGS. 1 and 2, according to one or more exemplary implementations of the present disclosure.

As illustrated in FIG. 3, process 300 begins with the step s301 of detecting, by a network element, a handover involving a UE device being served by a network. In the example illustrated in FIGS. 1 and 2, one or more of the network elements (or network functions) of CN 100 detects a handover involving UE device 110 between ANs 105-1 and 105-2, which can include handover tracking and notification on the underlying call session plane. More specifically, for a handover from AN 105-1 to AN 105-2—for example, from a 5G NR RAN to a Wi-Fi network-AMF 205 detects a handover connection with UE device 110 via N3IWF 290. In certain embodiments, a handover involving UE device 110 to a Wi-Fi connection via AN 105-2 can be detected through ePDG 292, either directly by AMF 205 or through SMF/PGW-C 210. The example shown in FIGS. 1 and 2 can be termed an inter-technology handover. A handover in an opposite direction, for example, from AN 105-2 to 105-1, can be detected by AMF 205. Notifications of other types of handovers are also applicable, such as inter radio access technology (inter RAT) handovers, inter network (or inter system) handovers, inter slice handovers, to name a few. Inter RAT handovers, such as between 5G NR RANs, between 5G NR RANs (e.g., a voice over new radio (VONR) call) and 4G LTE RANs (e.g., a voice over long-term evolution (VOLTE) call), or the like, can be detected by AMF 205, or a MME 206. Inter network handovers, which can include handovers between public and private networks, can be detected via AMF 205 and/or SEPP 296. Inter slice handovers can be detected via AMF 205 and/or NSSF 294.

Next, at step s305, a handover notification message is issued from the network element at which the handover is detected to an application element. According to one or more exemplary implementations, with reference to FIG. 2, AMF 205, upon receiving an indication that a handover involving UE device 110 has been initiated, issues a handover notification message to API 265-2, for example, through NEF 260. The handover notification message contains information about the details of the handover, including but not limited to a time of the handover event, a determined location of the handover event, a type and direction of the handover (e.g., technology, RAT, network, or slice), a PLMN and/or cell identification (ID), a counter of number updates, an indication of an initial handover or an update, an indication of handover success or failure, to name a few. Thus, information regarding the RAT and the handover is supplied to API 265-2 for processing with respect to one or more application features being executed at, or provided to, UE device 110.

According to one or more exemplary implementations, the handover notification message contains the information in one or more indicators on an application layer associated with API 265-2 and is issued to API 265-2 via NEF 260. For handovers to a 5G NR RAN such as AN 105-1, AMF 205 provides information regarding a change of a cell or a RAT after a handover based on a location reporting control message from, for example, AN 105-1. In certain embodiments, a proprietary communication interface can be established between API 265-2 and AMF 205 for this handover notification communication, as illustrated by the dot-dash line in FIG. 2.

Referring back to FIG. 3, process 300 next proceeds to step s310, where API 265-2 processes the handover notification message information to identify relevant application and/or network features, and to determine whether any feature (and/or policy) changes are to be made as a result of the handover.

If API 265-2 determines that no feature updates or service changes are necessitated by the handover (“No”) in step s310, process 300 ends.

If API 265-2 determines that one or more feature updates and/or service changes should be executed as a result of the handover (“Yes” at step s310), process 300 proceeds to step s315, where API 265-2 issues (or transmits) one or more messages associated with the determined feature update(s) and/or service change(s) to the corresponding appropriate network element(s) (or network function(s)), e.g., PCF 245, AF(s) 265, LMF 275, GMLC 280, SMLC 284, NWDAF 285, external elements such as PSAP 2315, to name a few. In certain embodiments, API 265-2 can execute features that comprise message communications to elements that are external to CN 100, such as AN 105, UE device 110, external network 150, to name a few.

The determined feature update(s) and/or service change(s) can comprise LBS, analytics, policy notifications, QoS changes, to name a few. In certain embodiments, API 265-2 can also perform network coverage determinations based on the handover notifications for enhancing coverage of, for example, AN 105-1 associated with CN 100. Thus, at step s315, API 265-2 facilitates one or more application features at UE device 110 and/or CN 100 in correspondence with the handover detected at step s301.

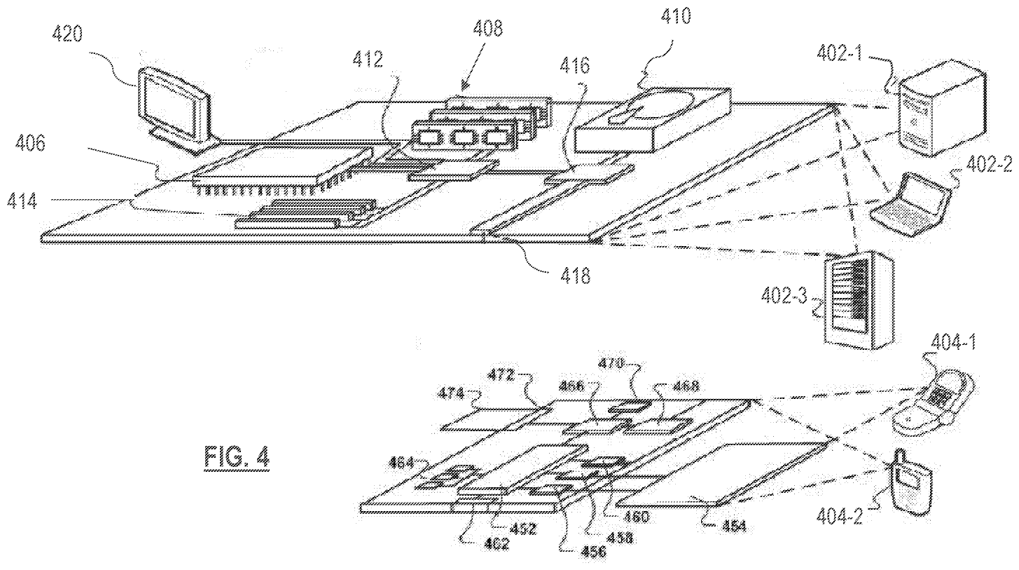

FIG. 4 shows exemplary computing apparatus 402 and a mobile computing device 404 that can be used to implement the techniques described herein. Computing apparatus 402 is intended to represent various forms of digital computers, such as laptops, desktops, workstations, personal digital assistants, servers, blade servers, mainframes, and other appropriate computers. The mobile computing device 404 is intended to represent various forms of mobile devices, such as personal digital assistants, cellular telephones, smartphones, AR devices, and other similar computing devices. The components shown in FIG. 4, including connections and relationships, and their functions, are meant to be exemplary only, and are not meant to limit implementations of the disclosures described and/or claimed in this document.

The computing apparatus 402 can include a processor 406, a memory 408, a storage device 410, a high-speed interface 412 connecting the memory 408 and multiple high-speed expansion ports 414, and a low-speed interface 416 connecting a low-speed expansion port 418 and the storage device 410. Each of the processor 406, the memory 408, the storage device 410, the high-speed interface 412, the high-speed expansion ports 414, and the low-speed interface 416, are interconnected using various buses, and can be mounted on a common motherboard or in other manners as appropriate. The processor 406 can process instructions for execution within the computing apparatus 402, including instructions stored in the memory 408 or on the storage device 410 to display graphical information for a graphical user interface (GUI) on an external input/output device, such as a display 420 coupled to the high-speed interface 412. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 408 stores information within the computing apparatus 402. In some implementations, the memory 408 is a volatile memory unit or units. In some implementations, the memory 408 is a non-volatile memory unit or units. The memory 408 can also be another form of computer-readable medium, such as a magnetic or optical disk.

The storage device 410 is capable of providing mass storage for the computing apparatus 402. In some implementations, the storage device 410 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier and can contain instructions that, when executed, perform one or more methods, such as those described above. The computer program product can also be tangibly embodied in a computer- or machine-readable medium, such as the memory 408, the storage device 410, or memory on the processor 406.

The high-speed interface 412 can be configured to manage bandwidth-intensive operations, while the low-speed interface 416 can be configured to manage lower bandwidth-intensive operations. Of course, one of ordinary skill in the art will recognize that such allocation of functions is exemplary only. In some implementations, the high-speed interface 412 is coupled to the memory 408, the display 420 (e.g., through a graphics processor or accelerator), and to the high-speed expansion ports 414, which can accept various expansion cards (not shown). In an implementation, the low-speed interface 416 is coupled to the storage device 410 and the low-speed expansion port 418. The low-speed expansion port 418, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter (not shown).

As noted herein, computing apparatus 402 can be implemented in a number of different forms, such as a standard server 402-1, or multiple times in a group of such servers. In addition, it can be implemented in a personal computer, such as a laptop computer 402-2. It can also be implemented as part of a rack server system 402-3. Alternatively, components from the computing apparatus 402 can be combined with other components in a mobile device, such as a mobile computing device 404. Each of such devices can contain one or more of the computing apparatus 402 and the mobile computing device 404, and an entire system can be made up of multiple computing devices communicating with each other. As an example, such multiple computing devices can be implemented, at least in part, in one or more of CN 100, AN(s) 105, and external network 150. As another example, computing apparatus 402 in the form of a personal computer can be implemented as UE device 110 described with respect to FIGS. 1 and 2.

The mobile computing device 404 includes a processor 452; a memory 464; an input/output device, such as a display 454; a communication interface 466; and a transceiver 468; among other components. The mobile computing device 404 can also be provided with a storage device, such as a micro-drive or other device, to provide additional storage. Each of the processor 452, the memory 464, the display 454, the communication interface 466, and the transceiver 468, are interconnected using various buses, and several of the components can be mounted on a common motherboard or in other manners as appropriate. In some implementations, the mobile computing device 404 can include a camera device(s). The processor 452 can execute instructions within the mobile computing device 404, including instructions stored in the memory 464. The processor 452 can be implemented as a chipset of chips that include separate and multiple analog and digital processors. For example, the processor 452 can be a System on a Chip (SoC) processor, System In a Package (SIP) processor, an Application-Specific Integrated Circuit (ASIC) processor, a Complex Instruction Set Computer (CISC) processor, a Reduced Instruction Set Computer (RISC) processor, or a Minimal Instruction Set Computer (MISC) processor.

The processor 452 can provide, for example, for coordination of the other components of the mobile computing device 404, such as control of user interface (UI), applications run by the mobile computing device 404, and/or wireless communication by the mobile computing device 404. The processor 452 can communicate with a user through a control interface 458 and a display interface 456 coupled to the display 454. The display 454 can be, for example, a Thin-Film-Transistor Liquid Crystal Display (TFT) display, an Organic Light Emitting Diode (OLED) display, or other appropriate display technology. The display interface 456 can include appropriate circuitry for driving the display 454 to present graphical and other information to a user. The control interface 458 can receive commands from a user and convert them for submission to the processor 452. In addition, an external interface 462 can provide communication with the processor 452, so as to enable near area communication of the mobile computing device 404 with other devices. The external interface 462 can provide, for example, for wired communication in some implementations, or for wireless communication in other implementations, and multiple interfaces can also be used.

The memory 464 stores information within the mobile computing device 404. The memory 464 can be implemented as one or more of a computer-readable medium or media, a volatile memory unit or units, or a non-volatile memory unit or units. An expansion memory 474 can also be provided and connected to the mobile computing device 404 through an expansion interface 472, which can include, for example, a Single in Line Memory Module (SIMM) card interface. The expansion memory 474 can provide extra storage space for the mobile computing device 404, or can also store applications or other information for the mobile computing device 404. Specifically, the expansion memory 474 can include instructions to carry out or supplement the processes described above, and can include secure information also. Thus, for example, the expansion memory 474 can be provided as a security module for the mobile computing device 404, and can be programmed with instructions that permit secure use of the mobile computing device 404.

In addition, secure applications can be provided via the SIMM cards, along with additional information, such as placing identifying information on the SIMM card in a non-hackable manner. The memory can include, for example, flash memory and/or non-volatile random access memory (NVRAM), as discussed below. In some implementations, instructions are stored in an information carrier. The instructions, when executed by one or more processing devices, such as processor 452, perform one or more methods, such as those described above. The instructions can also be stored by one or more storage devices, such as one or more computer-readable or machine-readable mediums, such as the memory 464, the expansion memory 474, or memory on the processor 452. In some implementations, the instructions can be received in a propagated signal, such as, over the transceiver 468 or the external interface 462. The mobile computing device 404 can communicate wirelessly through the communication interface 466, which can include digital signal processing circuitry where necessary. The communication interface 466 can provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 4G and 5G technologies. Such communication can occur, for example, through the transceiver 468 using a radio frequency. In addition, short-range communication, such as using a Bluetooth or Wi-Fi, can occur.

In addition, a Global Positioning System (GPS) receiver module 470 can provide additional navigation- and location-related wireless data to the mobile computing device 404, which can be used as appropriate by applications running on the mobile computing device 404. The mobile computing device 404 can also communicate audibly using an audio codec 460, which can receive spoken information from a user and convert it to usable digital information. The audio codec 460 can likewise generate audible sound for a user, such as through a speaker, e.g., in a handset of the mobile computing device 404. Such sound can include sound from voice telephone calls, can include recorded sound (e.g., voice messages, music files, etc.) and can also include sound generated by applications operating on the mobile computing device 404. The mobile computing device 404 can be implemented in a number of different forms—for example, as shown in FIG. 4, in a mobile phone device 404-1 or a personal digital assistant device 404-2. Mobile computing device 404 can also be implemented, at least in part, in a tablet device, a laptop computing device, a smartphone, a virtual reality (VR) device, an augmented reality (AR) device, or other similar mobile device. Thus, as an example, it can be implemented, at least in part, in the UE device 110 described with respect to FIGS. 1 and 2.

According to one or more exemplary implementations, CN 100, UE device 110, AN(s) 105, and external network 150 each comprises one or more of computing apparatus 402 and/or one or more of mobile computing device 404 for carrying out the above-described features using hardware and/or software components thereof. In certain embodiments, the elements of CN 100 described with reference to FIG. 2 above can be implemented, at least in part, with one or more of computing apparatus 402 and/or one or more of mobile computing device 404 using hardware and/or software components thereof. In embodiments, at least a portion of CN 100 and/or AN(s) 105 can be implemented using a cloud infrastructure, which can comprise multiple computing apparatuses 402 and/or mobile computing devices 404.

The following are non-exhaustive examples of the features that can be executed by API 265-2 at step s315 as a consequence of a handover that involves a change to a higher layer application feature.

### Example 1—Location Determinations

LCS methods during voice over NR (VONR) calls, or over any cellular network, and location determinations during voice over Wi-Fi (VoWiFi) calls are separate and independent from one another. As such, location determination methods or schemes employed during calls depend upon the access technology of the UE device (110) when a call is initiated, for example, either to a 5G NR AN such as AN 105-1 or a Wi-Fi AN such as AN 105-2. Standalone VoWiFi location determinations are based on single notifications of coarse locations, for example, the location of a Wi-Fi AP, such as AP 299 illustrated in FIG. 2. Thus, determined locations for LBS on the application layer during a VoWiFi call can often not be as accurate when compared to LCS provided for VONR cellular calls using LMF 275, GMLC 280, and/or SMLC 284. Furthermore, handovers can require that an emergency call be disconnected and reestablished.

In view of these shortcomings, according to one or more exemplary implementations, if API 265-2 determines that an emergency call is ongoing at UE device 110 at step s310, it acts to preserve one or more connections, or subscription(s), to LMF 275, GMLC 280, and/or SMLC 284 and to thereby maintain LCS provisioning for the ongoing emergency call even after the handover to AN 105-2. Accordingly, at step s315, API 265-2 transmits one or more messages to LMF 275, GMLC 280, and/or SMLC 284 to preserve a connection (or subscription), and/or to query a current location of the UE device 110. In certain embodiments, API 265-2 can determine to store a current location determined using LMF 275, GMLC 280, and/or SMLC 284 for confirmation of subsequent location determinations over VoWiFi after the handover to AN 105-2.

For a handover from AN 105-2 to AN 105-1, API 265-2 determines, at step s310, to initiate control plane location technologies by establishing, at step s315, one or more connections, or subscription(s), to LMF 275, GMLC 280, and/or SMLC 284 to enhance location accuracy for an ongoing emergency call. Advantageously, the present disclosure provides for enhancing location determinations for emergency calls that are initiated over VoWiFi when a handover to VONR (or LTE or any cellular network) takes place by initiating 5G NR LCS (or other network LCS) upon detecting such a handover. Moreover, as noted above, the present disclosure advantageously provides for maintaining LCS provided for a call initiated over VONR/LTE, or any cellular network, after a handover to VoWiFi takes place.

In correspondence with the foregoing, API 265-2 can further provide support for location continuity during emergency calls by communicating, at step s315, a current, ongoing, and/or updated location(s) to a public safety answering point (PSAP), for example, PSAP 2315 via external network 150 illustrated in FIG. 2. Accordingly, in certain embodiments, API 265-2 can further relay a determined location of the UE device 110 from LMF 275, GMLC 280, and/or SMLC 284 to the PSAP using a Presence Information Data Format Location Object (PIDF-LO) at step s315, when prompted, and/or periodically thereafter. In certain embodiments, API 265-2 can include functionality for comparing and/or confirming, at step s315 and/or thereafter, location determinations using a VONR Control Plane emergency location system (ELS) (e.g., AN 105-1) with ones using a VoWifi PIDF-LO (e.g., AN 105-2) within a predetermined time period (and/or other parameter(s)) in response to a handover notification message from AMF 205 received at step s305.

In embodiments, other applications and/or audio/video calls that utilize LBS can similarly incorporate API 265-2 for preserving or establishing 5G NR LCS based on a handover notification. Accordingly, at step s310, API 265-2 determines the appropriate LCS-related features and, at step s315, executes the determined features in response to the handover notification received at step s305. In certain embodiments, API 265-2 can incorporate one or more display elements (not shown) in, for example, a graphical user interface—that are delivered to UE device 110 for displaying the LCS change, selecting the LCS change, notifying the RAT change, to name a few.

### Example 2—Application Services

For consumer applications such as video display applications, a handover can result in a discontinuity or degradation of service. Accordingly, in one exemplary implementation, API 265-2 incorporates an interface to a video display application that triggers a feature action upon receiving a handover notification at step s305. Correspondingly, API 265-2 determines, at step s310, that UE device 110 is executing the video display application with an ongoing video stream and, thus, determines to issue, at step s315 or thereafter, a request to the video display application for a state change as a consequence of the handover to account for any changes in access technology, connection status, or the like, to maximize QoE. In embodiments, the state change can include a change in frame rate, resolution, or the like, for a video stream to account for a change in network resources available, e.g., QoS, resulting from the handover, which can be ascertained, for example, by issuing at step s315 a service update message that comprises a data request to PCF 245. API 265-2 can also issue a request for a time stamp of an ongoing video stream at step s315—for example, from an AF 265 of the video display application—to ensure continuity of the stream after a handover, where a received time stamp of the ongoing video stream during the handover can be referenced by the video display application for a subsequent return to a time point of the video stream by a subscriber at UE device 110.

### Example 3—Analytics

According to one or more exemplary implementations of the present disclosure, API 265-2 incorporates functionality for providing analytical data to one or more applications and/or network elements. In embodiments, the analytical data can include information regarding the handover that is conveyed in the handover notification message received at step s305. In one exemplary implementation, API 265-2 forwards analytical data associated with a handover to NWDAF 285 at step 315, either directly or through NEF 260, for AI/ML-based analytical processes, for example, in one or more processes related to network performance optimization at CN 100.

In certain embodiments, an application for analyzing network coverage for system enhancements can use the handover information for tracking and predicting movements of UE devices after handovers. Based on historical handover information, RAN resources, such as cell tower locations or the like, can be allocated accordingly, for example, via PCF 245. In view of the location determination and application service examples, API 265-2 can further include application layer analytical data for tracking and predicting applications, such as emergency calls, video display applications, or the like that are executed during certain handovers for informing RAN resource allocations, which can be set via PCF 245. Correspondingly, inter slice handover information can be used for allocating resources among slices supported by a particular network, e.g., CN 100.

As an additional example, the handover analytical data can include data indicative of a coverage border between AN 105-1 and AN 105-2 or one with another AN 105 of a roaming partner. Thus, such data can inform RAN resource allocations to optimize coverage and/or border roaming, for example, of AN 105-1 and/or AN 105-2 with each other or another AN 105.

### Example 4—Policy Decisions

According to one or more exemplary implementations, API 265-2 incorporates features for providing updated policy notifications and/or making higher layer policy-related decisions based on a handover notification. In one implementation, API 265-2 interacts with PCF 245 and issues a feature update notification to UE device 110 at step 315, which comprises a notification to the subscriber at the UE device 110 about different service offerings between ANs 105 before and after a handover (or services that would be gained or lost as a result of a handover), for example, between AN 105-1 and AN 105-2. In certain embodiments, the service offerings can be rendered on a GUI at the UE device 110 for display in a notification message. Accordingly, a subscriber at UE device 110 can decide between ANs 105, for example, by moving UE device 110 based on the notification. In certain embodiments, API 265-2 can provide UE device 110 with a subscriber selection (e.g., a selection interface rendered on a GUI at UE device 110) between, for example, AN 105-1 and AN 105-2 when it determines that UE device 110 is located where there is substantial overlapping coverage between these ANs.

Additionally, for private networks or non-public networks (NPNs), policy and service decisions relating to UE devices (e.g., UE device 110) among coverage areas, including one or more closed access group (CAG) areas, can be effected based on a detected handover.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). To facilitate understanding, like reference numerals have been used, where possible, to designate like elements common to the figures. In certain instances, a letter suffix following a dash ( . . . -b) denotes a specific example of an element marked by a particular reference numeral (e.g., 210-b). Description of elements with references to the base reference numerals (e.g., 210) also refer to all specific examples with such letter suffixes (e.g., 210-b), and vice versa.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof, and are meant to encompass the items listed thereafter and equivalents thereof as well as additional items.

What is claimed is:

1. A method comprising:
detecting, at a network function of a core network, a handover of a connection between a user equipment (UE) device and the core network from a first access network to a second access network;
issuing, at the network function to an application programming interface (API) of the core network, a handover notification associated with the detected handover;
determining, at the API, one or more service update messages to another one or more network functions of the core network, wherein each of said one or more service update messages relates to a respective one or more application features at one or more of the UE device and the core network, and is associated with a change from the first access network to the second access network; and
issuing, at the API, the determined one or more service update messages to the other one or more network functions to facilitate the respective one or more application features at the one or more of the UE device and the core network in correspondence with the detected handover.

2. The method of claim 1, wherein the handover notification incorporates at least one information indicator on an application layer associated with the API, the at least one information indicator being selected from the group consisting of: a time of an event associated with the detected handover, a location of the event associated with the detected handover, a type of the handover, a direction of the handover, a Public Land Mobile Network (PLMN) identification (ID), a cell ID, an update counter, an initial attempt indicator for the handover or an update, and a handover attempt success indicator.

3. The method of claim 1, wherein the network function is an access and mobility management function (AMF) or a mobility management entity (MME), and
the handover notification is issued to the API via a network exposure function (NEF).

4. The method of claim 1, wherein the another one or more respective network functions are selected from the group consisting of: a policy control function (PCF), a network function repository function (NRF), a session management function (SMF), a location management function (LMF), a gateway mobility location center (GMLC), a serving mobile location center (SMLC), a network exposure function (NEF), an application function (AF), a user plane function (UPF), and a network data analytics function (NWDAF).

5. The method of claim 1, wherein at least one of the one or more application features relates to a UE device location service (LCS) and at least one of the one or more service update messages relates to a change from a first positioning determination scheme associated with the first access network to a second positioning determination scheme associated with the second access network, and
the at least one service update message comprises a data request to a location management function (LMF) or a gateway mobility location center (GMLC).

6. The method of claim 5, wherein the first access network comprises a wireless network conforming to a Wi-Fi standard protocol and the second access network comprises a radio access network conforming to a radio communication standard protocol, and the method further comprises:
transmitting, at the API, location data received from the LMF or the GMLC to a public safety answering point (PSAP) for an ongoing emergency call that is initiated via the first access network.

7. The method of claim 5, wherein the first access network comprises a radio access network conforming to a radio communication standard protocol and the second access network comprises a wireless network conforming to a Wi-Fi standard protocol, and the method further comprises:
transmitting, at the API, location data received from the LMF or the GMLC to a public safety answering point (PSAP) for an emergency call connected via the second access network.

8. The method of claim 1, wherein at least one of the one or more application features relates to a video display application of an ongoing video being displayed at the UE device, and
the one or more service update messages comprises a data request to a policy control function (PCF) to determine a change in network resources available for the video display application.

9. The method of claim 8, further comprising:
issuing, at the API, at least one of a state change request and a time stamp request to the video display application.

10. The method of claim 1, wherein at least one of the one or more application features relates to one or more analytical processes associated with the core network,
the one or more service update messages comprise analytical data for a network data analytics function (NWDAF), and
the NWDAF comprises one or more of an analytics logical function (AnLF) and a model training logical function (MTLF).

11. A system, comprising:
an interface adapted to communicate with one or more user equipment (UE) devices;
a processor; and
a non-transitory computer-readable memory operatively connected to the processor and having stored thereon machine-readable instructions that cause, when executed, the processor to:
detect, at a network function of a core network, a handover of a connection between a user equipment (UE) device and the core network from a first access network to a second access network;
issue, at the network function to an application programming interface (API) of the core network, a handover notification associated with the detected handover;
determine, at the API, one or more service update messages to another one or more network functions of the core network, wherein each of said one or more service update messages relates to a respective one or more application features at one or more of the UE device and the core network, and is associated with a change from the first access network to the second access network; and
issue, at the API, the determined one or more service update messages to the other one or more network functions to facilitate the respective one or more application features at the one or more of the UE device and the core network in correspondence with the detected handover.

12. The system of claim 11, wherein the handover notification incorporates at least one information indicator on an application layer associated with the API, the at least one information indicator being selected from the group consisting of: a time of an event associated with the detected handover, a location of the event associated with the detected handover, a type of the handover, a direction of the handover, a Public Land Mobile Network (PLMN) identification (ID), a cell ID, an update counter, an initial attempt indicator for the handover or an update, and a handover attempt success indicator.

13. The system of claim 11, wherein the network function is an access and mobility management function (AMF) or a mobility management entity (MME), and
the handover notification is issued to the API via a network exposure function (NEF).

14. The system of claim 11, wherein the another one or more respective network functions are selected from the group consisting of: a policy control function (PCF), a network function repository function (NRF), a session management function (SMF), a location management function (LMF), a gateway mobility location center (GMLC), a serving mobile location center (SMLC), a network exposure function (NEF), an application function (AF), a user plane function (UPF), and a network data analytics function (NWDAF).

15. The system of claim 11, wherein at least one of the one or more application features relates to a UE device location service (LCS) and at least one of the one or more service update messages relates to a change from a first positioning determination scheme associated with the first access network to a second positioning determination scheme associated with the second access network, and
the at least one service update message comprises a data request to a location management function (LMF) or a gateway mobility location center (GMLC).

16. The system of claim 15, wherein the first access network comprises a wireless network conforming to a Wi-Fi standard protocol and the second access network comprises a radio access network conforming to a radio communication standard protocol, and the machine-readable instructions cause, when executed, the processor to further:
transmit, at the API, location data received from the LMF or the GMLC to a public safety answering point (PSAP) for an ongoing emergency call that is initiated via the first access network.

17. The system of claim 15, wherein the first access network comprises a radio access network conforming to a radio communication standard protocol and the second access network comprises a wireless network conforming to a Wi-Fi standard protocol, and the machine-readable instructions cause, when executed, the processor to further:
transmit, at the API, location data received from the LMF or the GMLC to a public safety answering point (PSAP) for an emergency call connected via the second access network.

18. The system of claim 11, wherein at least one of the one or more application features relates to a video display application of an ongoing video being displayed at the UE device, and the one or more service update messages comprise a data request to a policy control function (PCF) to determine a change in network resources available for the video display application.

19. The system of claim 18, wherein the machine-readable instructions cause, when executed, the processor to further:
issue, at the API, at least one of a state change request and a time stamp request to the video display application.

20. The system of claim 11, wherein at least one of the one or more application features relates to one or more analytical processes associated with the core network,
the one or more service update messages comprise analytical data for a network data analytics function (NWDAF), and
the NWDAF comprises one or more of an analytics logical function (AnLF) and a model training logical function (MTLF).
